(19) United States
(12) Patent Application Publication
(10) Pub. No.: US 2026/0247132 A1
(43) Pub. Date: Aug. 20, 2026

(54) METHODS AND PROCEDURES FOR ADDRESSING CONVENTIONS OF NETWORK FUNCTIONS IN SERVICE-CENTRIC USER EQUIPMENT

(71) Applicant: InterDigital Patent Holdings, Inc., Wilmington, DE (US)

(72) Inventor: Sebastian Robitzsch, London (GB)

(73) Assignee: InterDigital Patent Holdings, Inc., Wilmington, DE (US)

(21) Appl. No.: 18/994,037

(22) PCT Filed: Jul. 18, 2023
(86) PCT No.: PCT/US2023/027960

§ 371 Date: Jan. 13, 2025

Related U.S. Application Data
(60) Provisional application No. 63/390,743, filed on Jul. 20, 2022.
(60) Provisional application No. 63/427,601, filed on Nov. 23, 2022.

(51) Int. Cl. H04W 8/18; H04L 61/3015; H04L 101/654

(52) U.S. Cl. CPC H04W 8/183; H04L 61/3025; H04L 2101/654

(57) ABSTRACT

A method performed by a wireless transmit/receive unit (WTRU) may be provided for communicating with a network function (NF). An example WTRU may determine a subscription permanent identifier (SUPI) and a SUPI type. The WTRU may determine, based on the SUPI type, a parent domain associated with the network node. The WTRU may determine a partial qualified domain name (PQDN) associated with the network node. The WTRU may determine a fully qualified domain name (FQDN) for the network node based on the parent domain and the PQDN. The WTRU may send a message to the network node using the determined FQDN to address the network node.

### CROSS-REFERENCE TO RELATED APPLICATIONS

This application claims the benefit of U.S. Provisional Patent Application No. 63/390,743, filed Jul. 20, 2022, and U.S. Provisional Patent Application No. 63/427,601, filed Nov. 23, 2022, the contents of which are hereby incorporated by reference herein.

### BACKGROUND

An internet protocol (IP) may be provided. IP may be used to provide a network address for a server on a network. IP may be used to provide a wireless transmit/receive unit (WTRU) with a network address on the network. And other protocols may be used to provide the server address and/or the WTRU address. For example, a fully qualified domain name and/or a partially qualified domain name may be used.

### SUMMARY

This disclosure describes methods for a wireless transmit/receive unit (WTRU) and/or Network Function consumers to determine an addressing identifier of a producer they aim to reach, which may occur without going through a Network Resolution Function. In some embodiments, when a WTRU starts to attach to a Core Network, a Network Resolution Function (NRF), which may be a part of the Core Network, may not be available to the User Equipment.

Identifiers for producers may be of a protocol type. For example, identifiers for producers may be of internet protocol (IP) address type or a fully-qualified domain name (FQDN), In an example, an NRF may hold one or more Network Function (NF) registrations and may be responsible (e.g., solely responsible) for selecting which producer instance or set of instances (e.g., an NF set) a consumer request may be sent to. In an end-to-end Service-Based Architecture, where the NAS may be replaced by SBIs on the WTRU and access and mobility management function (AMF), WTRUs may not have the means to contact the NRF to obtain an identifier for a producer they aim to reach. Furthermore, if the WTRU is a producer, Core Network consumers (other than the WTRU) may not have a means of addressing the WTRU.

The communication attempt of one or more consumers may involve one or more NRFs, which may be the NRF across one or more Communication Models (e.g., model A, model B, model C, and/or model D as described herein). This may create a delay in establishing a service and may create additional signaling, which may lead to higher energy consumption. In an example, such as in a multi-vendor Core Network deployment, a NF may be provided by a vendor (e.g., a specific vendor) and the logic within the NRF to select an appropriate producer Instance (e.g., the most appropriate producer instance) or a NF set, may rely on the vendor.

As described herein, devices, methods, and/or instrumentalities may be provided for unifying the naming convention of producer identifiers using FQDNs (e.g., FQDNs only), which may include the WTRU, are described herein. Devices, methods, and/or instrumentalities may be provided to address how one or more UEs may determine the FQDN, which may occur without communicating with the NRF, devices, methods, and/or instrumentalities may be provided to provide signaling that one or more consumers may use (e.g., each consumer) to query the NRF for the identifier of the producer they want to reach is described. For example, a communication model (referred to herein as Model E) may be introduced to position the service communication proxy (SCP) as a transparent routing component that may be indirectly addressed. In some embodiments, the SCP may offer a programmable application programming interface (API) to configure (e.g., constraints and affinities under which consumer and producer instances may be matched and/or kept together).

A method and/or a WTRU may be provided for communication with an NRF. An example WTRU may determine a subscription permanent identifier (SUPI) and a SUPI type. The WTRU may determine, based on the SUPI type, a parent domain associated with the network node. The WTRU may determine a partial qualified domain name (PQDN) associated with the network node. The WTRU may determine a fully qualified domain name (FQDN) for the network node based on the parent domain and the PQDN. The WTRU may send a message to the network node using the determined FQDN to address the network node.

The message to the network node may include an access token request. The network node may be a network repository function (NRF). The WTRU may receive, from the NRF, a message that includes an access token response message. The network node may be an access and mobility management function (AMF). The message to the network node may include a packet data unit (PDU) session establishment request. The WTRU may determine a slice type or service type associated with the message to the network. The WTRU may modify the PQDN based on the slice type or the service type.

On a condition that the SUPI type is an international mobile subscriber identity (IMSI), the WTRU may determine the parent domain associated with the network node based on a mobile country code (MCC) as a top-level domain, and a mobile network code (MNC) as a subdomain. On a condition that the SUPI type is a network access identifier (NAI), the WTRU may determine that the parent domain associated with the network node is the NAI. The WTRU may determine the SUPI and the SUPI type by reading the SUPI and the SUPI type from a universal subscriber identity module (USIM) of the WTRU.

The network node may be a network function (NF). The WTRU may determine a defined name associated with the NF. The WTRU may assign the defined name as the PQDN. The WTRU may receive a message from the network node based on the determined FQDN and a subscription concealed identifier (SUCI). The NF may be at least one of a network repository function (NRF), an access and mobility management function (AMF), a unified data management (UDM) function, a session management function (SMF), a policy control function (PCF), or a user plane function (UPF).

A first message may be sent to a network. The first message may indicate a request to attach to a network. The first message may indicate a subscription permanent identifier (SUPI). The first message may indicate a SUPI type. A second message may be received from the network. The second message may indicate a parent domain. A partially qualified domain name (PQDN) may be determined for the NRF. A fully qualified domain name (FQDN) may be determined for the NRF using the parent domain and the PQDN. A third message may be sent to the network. The third message may indicate a request for an access token. The third message may indicate the FQDN.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example system architecture of, for example, a 5G system, according to an embodiment;

FIG. 3 is a system diagram illustrating an example system architecture of, for example, a 5G system, according to an embodiment;

FIG. 4 is a message protocol chart illustrating an example indirect communication model, according to an embodiment;

FIG. 5 is a message protocol chart illustrating an example indirect communication model, according to an embodiment;

FIG. 6 shows an example structure of an identifier, such as a subscription concealed identifier (SUCI).

FIG. 7 is a message protocol chart illustrating a procedure for a consumer to retrieve consumer Information from an SCP, according to an embodiment; and

FIG. 8 is a message protocol chart illustrating a communication model for WTRU-initiated control plane communication, according to an embodiment.

FIG. 9 is an example message sequence chart.

### EXAMPLE NETWORKS FOR IMPLEMENTATION OF THE EMBODIMENTS

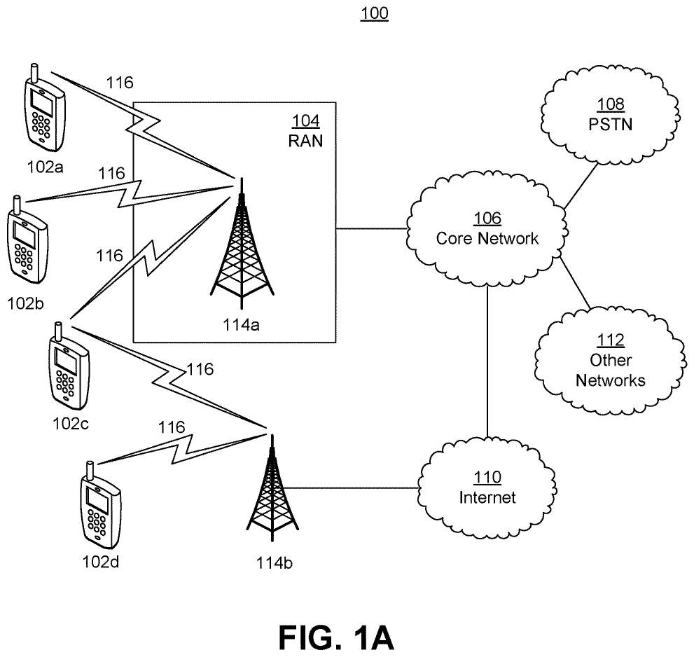

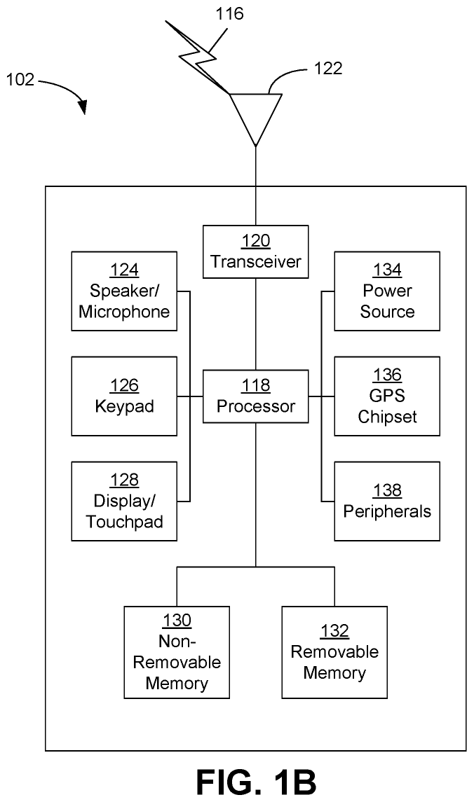

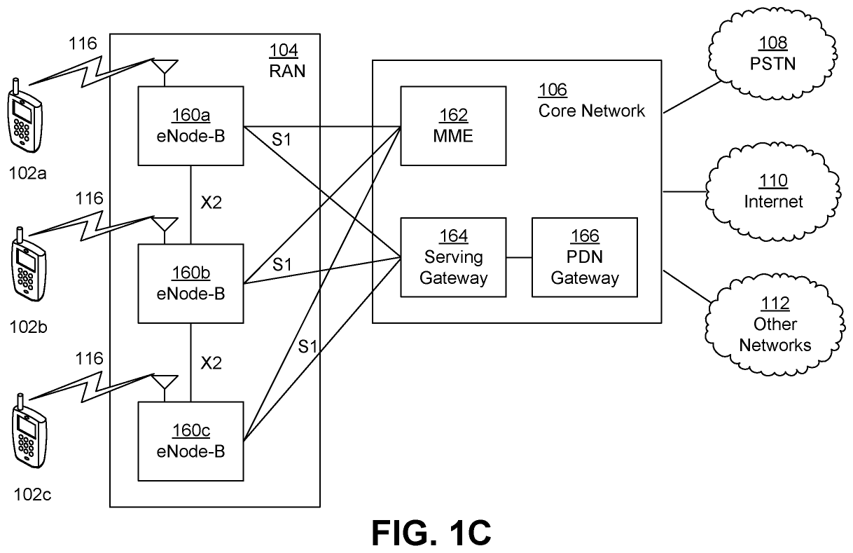

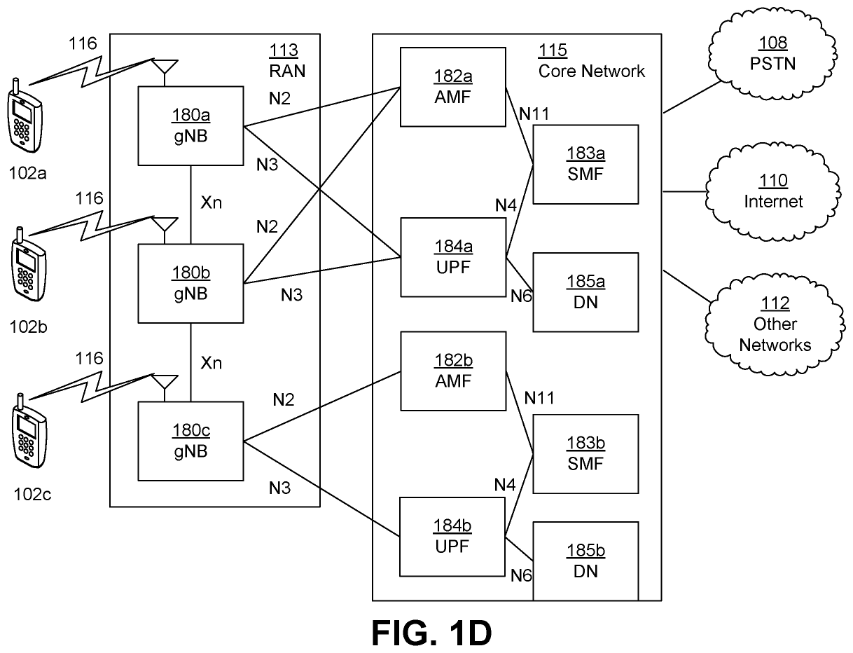

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 1020, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 1020, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 1020, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 1020, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 1020, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, It will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 1600 in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 1020 and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 1800 using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 1600 may serve as a mobility anchor for WTRUs 102a, 102b, 102c and gNBs 180a, 180b, 1800 may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, It will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 1800 in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### DETAILED DESCRIPTION

This disclosure describes methods for a wireless transmit/receive unit (WTRU) and/or network function consumers to determine an addressing identifier of a producer they aim to reach, which may occur without going through a network resolution function (NRF). In some embodiments, when a WTRU starts to communicate with a core network (e.g., when the WTRU attempts to attach to the core network) the NRF may not be available. For example, the NRF may not be available when a WTRU requests an access token.

Identifiers for producers may be of a protocol type. For example, identifiers for producers may be of internet protocol (IP) address type or a fully-qualified domain name (FQDN), In an example, an NRF may hold one or more network function (NF) registrations and may be responsible for selecting which producer instance or set of instances (e.g., an NF set) to which a consumer request will be sent. In an end-to-end service-based architecture (e.g., in which the non-access network stratum (NAS) protocol stack is replaced by SBIs utilizing HTTP on the WTRU and access and mobility management function (AMF), WTRUs may not have the means to contact the NRF to obtain an identifier for a producer that the WTRUs aim to reach. Furthermore, if the WTRU is a producer, core network consumers (e.g., other than the WTRU) may not have means of addressing the WTRU.

The communication attempt of one or more consumers may involve one or more NRFs, which may be the NRF across one or more communication models (e.g., model A, model B, model C, and/or model D, as described herein). This may delay establishing a service and may create additional signaling, which may lead to higher energy consumption. In an example, such as in a multi-vendor core network deployment, an NF may be provided by a vendor (e.g., a specific vendor). The logic within the NRF to select an appropriate producer instance (e.g., the most appropriate producer instance) or NF set may rely on another (e.g., a particular) vendor.

As described herein, devices, methods, and/or instrumentalities are provided for unifying the naming convention of producer identifiers using FQDNs (e.g., FQDNs only), which may include the WTRU. Devices, methods, and/or instrumentalities are provided to address how one or more WTRUs may determine the FQDN. The WTRU may determine the FQDN without communicating with the NRF. Devices, methods, and/or instrumentalities provided herein describe signaling that one or more consumers may use to query the NRF for the identifier of the producer that the consumer wants to reach. For example, a communication model (which may be referred to herein as Model E) may be introduced to position the service communication proxy (SCP) as a transparent routing component that may not be addressed explicitly through an identifier (e.g., as defined in Model C and D). For example, data and/or packets may be received and/or sent without using one or more addressing conventions. In some examples, the SCP may offer a programmable application programming interface (API) to configure constraints and/or affinities under which consumer and producer instances are matched and/or kept together.

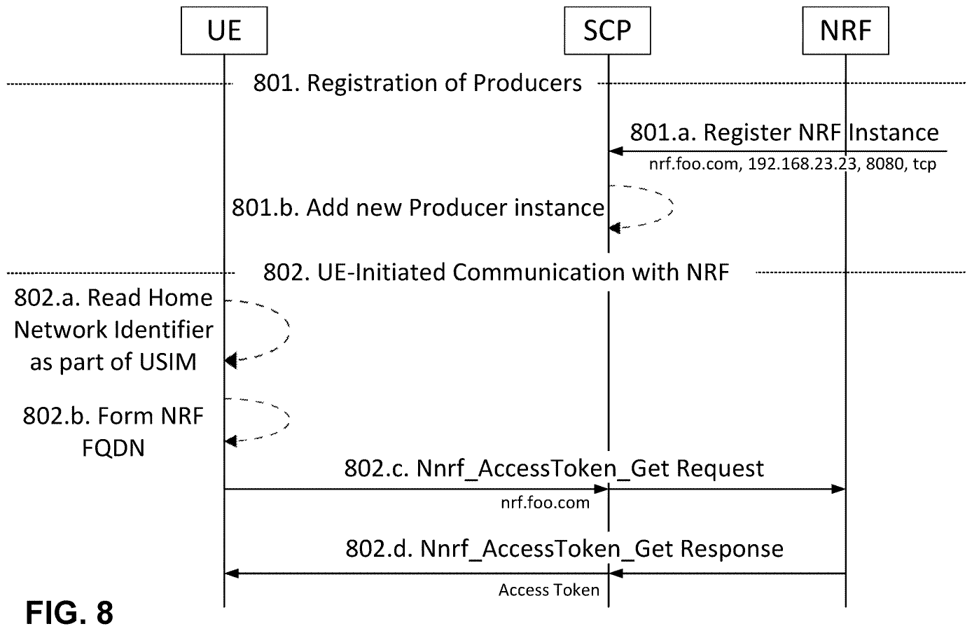

A method and/or a wireless/transmit receive unit (WTRU) for communicating with a network node (e.g., NF) are provided herein. A WTRU may determine a subscription permanent identifier (SUPI) and a SUPI type (e.g., by reading the SUPI and/or SUPI type from a universal subscriber identity module (USIM) of the WTRU, as illustrated in FIG. 8).

A first message may be sent to a network. The first message may indicate a request to attach to the network. The first message may indicate SUPI. The first message may indicate a SUPI type. The WTRU may determine a parent domain associated with a network node. For example, the WTRU may determine the parent domain based on information from a SIM in the WTRU. For example, the WTRU may read a public land mobile network identifier (PLMN ID) from the SIM and use the PLMN ID to form the parent domain, as described herein. A partially qualified domain name (PQDN) may be determined for the network node (e.g., NF) with which the WTRU may communicate (e.g., the PQDN may be associated with a network node and/or NF). A fully qualified domain name (FQDN) may be determined for the network node (e.g., NF) based on (e.g., using) the parent domain and the PQDN. The first message may indicate a request for an access token. The first message may indicate the FQDN. The first message may be sent to the network, for example, by sending the message to a device (e.g., a WTRU, a server, and/or the like) using the FQDN. The device may be connected to the network.

In an example, a second message may be received from the network. The second message may indicate an access token associated with a service and/or the FQDN. The second message may indicate that the request for the access token has been denied. The second message may further indicate a reason why the request for the access token has been denied.

The following acronyms are used herein: API (Application Programming Interface), DNS (Domain Name System), FQDN (Fully Qualified Domain Name), IMSI (International Mobile Subscriber Identity), JSON (JavaScript Object Notation), NAI (Network Access Identifier), NAS (Non-Network Access Stratum), NSSAI (Network Slice Selection Assistance Information), NF (Network Function), MCC (Mobile Country Code), MNC (Mobile Network Code), PDQN (Partially Qualified Domain Name), PLMN (Public Land Mobile Network), SBA (Service-Based Architecture), SBI (Service-Based Interface), Slice/Service type (SST), SUCI (Subscription Concealed Identifier), SUPI (Subscription Permanent Identifier).

Feature(s) associated with SBA are provided herein. For example, an SBA may include characteristics for a system architecture, such as a 5G system architecture. Such characteristics may include, for example, service-based interfaces (SBIs) for most interfaces of core network functions. SBIs may enforce, for example, HTTP/2 as the application layer protocol with JavaScript Object Notation (JSON)-encoded payload. Such characteristics may include, for example, consumers capable of sending requests over protocols (e.g., HTTP), and producers capable of responding to requests over protocols (e.g., HTTP). A consumer may be able to call a producer. SBI-enabled interfaces may not use numbers for an interface name, but may use the producer's acronym.

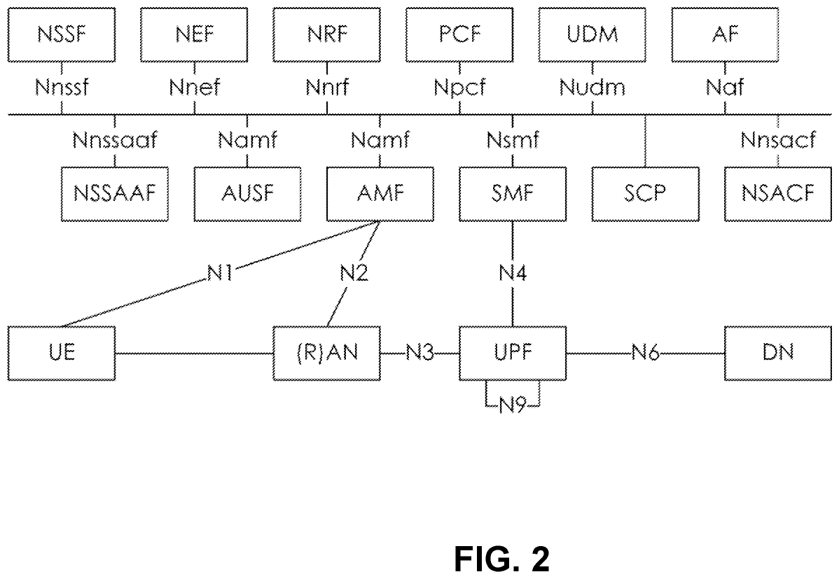

FIG. 2 is a system diagram illustrating an example system architecture of, for example, a 5G system, according to an embodiment. For example, FIG. 2 may introduce a Service Communication Proxy (SCP) into a system architecture, such as a 5G System Architecture. The SCP may be part of the Core Network but may not offer an SBI. The example UE shown in FIG. 2 may be a WTRU, which may be able to communicate with an AMF viaN1 via N2. In an example, the N4 interface may not be SBI-enabled.

An end-to-end service-based architecture may be provided. For example, a revised end-to-end service-based architecture may be provided. In embodiments, a NAS protocol may be used on an interface, such as on N1, to utilize SBA principles. For example, some embodiments may leverage an application protocol (e.g., HTTP) with an encoded payload (e.g., JSON-encoded payload) and/or removal of strict endpoint relationships of a specific interface, such as N1.

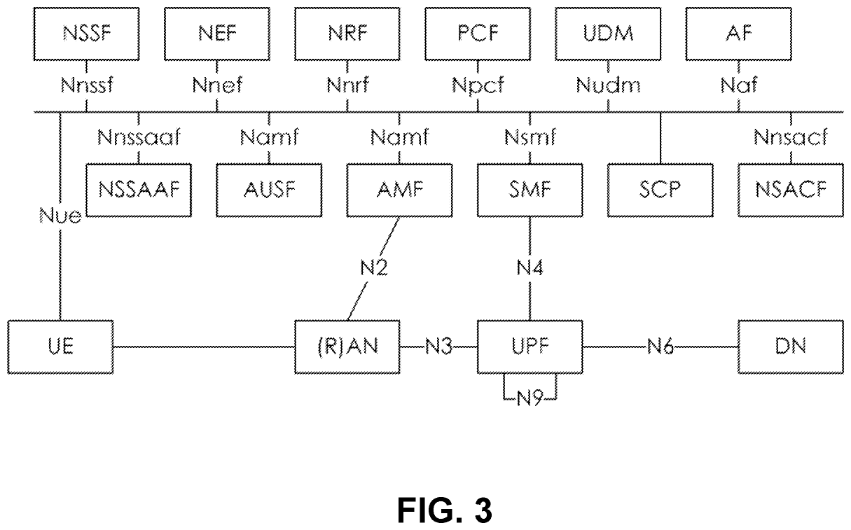

FIG. 3 is a system diagram illustrating an example system architecture of a 5G system, according to an embodiment. FIG. 3 depicts an example system architecture without N1. In such a system architecture, a WTRU may leverage the SCP for communication (e.g., direct communication) with one or more core network functions. In embodiments, a service-based interface (e.g., an Nue interface) may be used for cases where the WTRU is a producer and the network is a consumer.

Feature(s) associated with direct and indirect communication models are provided herein. For example, four communication models may be provided for SBI-enabled network function (NF) to NF communication. The four models may be categorized into direct and indirect communication, where direct models do not include an SCP, and indirect models do include an SCP. For example, a first direct communication model (e.g., Model A) may not include an NRF or an SCP. In Model A, consumer and producer instances communicate directly with each other. A second direct communication model (e.g., Model B) may enable the discovery of the producer instance to which a consumer should send its request via an NRF. Upon the NRF's decision, the consumer may communicate directly with the producer.

Model C is an example of an indirect communication model. In Model C, consumers may leverage an NRF to discover which producer instance to choose. The NRF may inform the consumer about the addressing identifier of an SCP (e.g., an IP address or a fully-qualified domain name (FQDN) of the SCP). The SCP may route a request and response. Model D is another example of an indirect communication model. In Model D, consumers may know (e.g., implicitly know) the addressing identifier of the SCP (e.g., IP address or FQDN), The consumers may issue a request to (e.g., directly to) the SCP. Consumers may add discovery and selection parameters, thereby allowing the SCP to discover the appropriate producer instance via the NRF. The SCP may route the request and response packets.

Table 1 provides a summary of the example communication models described herein for NF-to-NF interaction:

TABLE 1

| Communication | Model | Description |
|---|---|---|
| Direct | A | A NRF or SCP may not be in use. Consumer and producer instances |
| | | communicate (e.g., communicate directly with each other). |
| | B | The discovery of which producer instance a consumer may send its |
| | | request may be done via the NRF. Upon the NRF's decision, the |
| | | consumer may communicate (e.g., communicate directly) with the |
| | | producer. |
| Indirect | C | Consumers may leverage the NRF to discover which producer instance |
| | | may be appropriate to choose. The NRF may inform the consumer about |
| | | the addressing identifier of the SCP (IP address or FQDN). The request |
| | | and response may be routed by the SCP. |
| | D | Consumers may implicitly know the addressing identifier of the SCP (IP |
| | | address or FQDN) and may issue the request to (e.g., directly to) the |
| | | SCP. Consumers may add discovery and selection parameters allowing |
| | | the SCP to discover the appropriate producer instance via the NRF. The |
| | | SCP may route the request and response packets. |

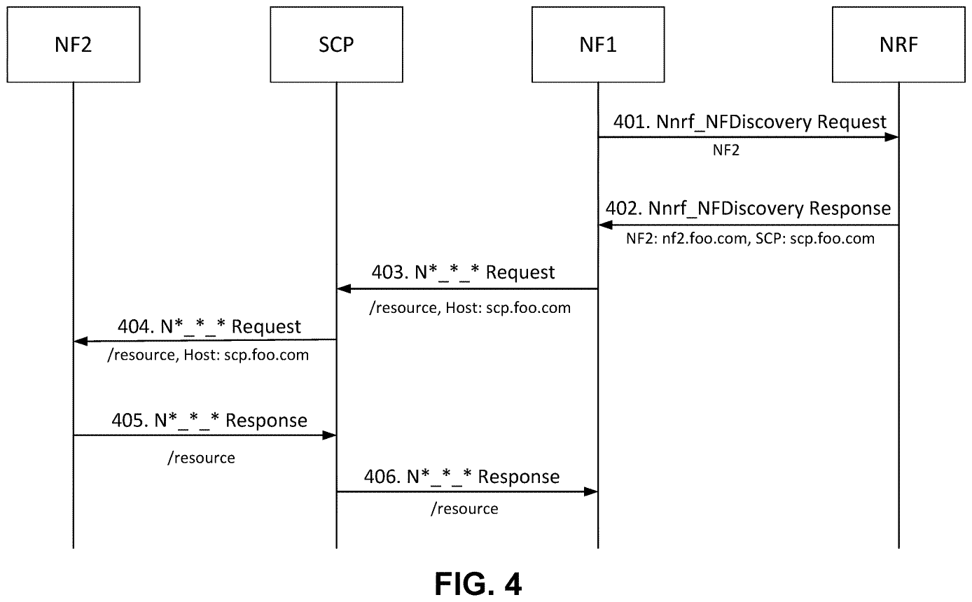

FIG. 4 is a message protocol chart illustrating an example indirect communication model, according to an embodiment. For example, FIG. 4 illustrates an indirect communication model in accordance with Model C, which is described herein. FIG. 4 illustrates indirect communication that may not have delegated discovery. At 401, NF1 may be a consumer and request a producer identifier and an SCP identifier from an NRF. At 402, the NRF may respond with an identifier for NF2 (e.g., a producer) and an SCP identifier. For example, in FIG. 4, NF2 may be registered under the host nf2.foo.com and the SCP serving that NF under scp.foo.com. At 403, NF1 may issue an HTTP request using an NF2-specific primitive for a resource (e.g., in FIG. 4, /resource) with SCP as a host. At 404, the SCP may rewrite the HTTP header to NF2's hostname and route the request to an NF2 instance. At 405, NF2 may send back the response for the resource. At 406, SCP may route such a response to consumer NF1.

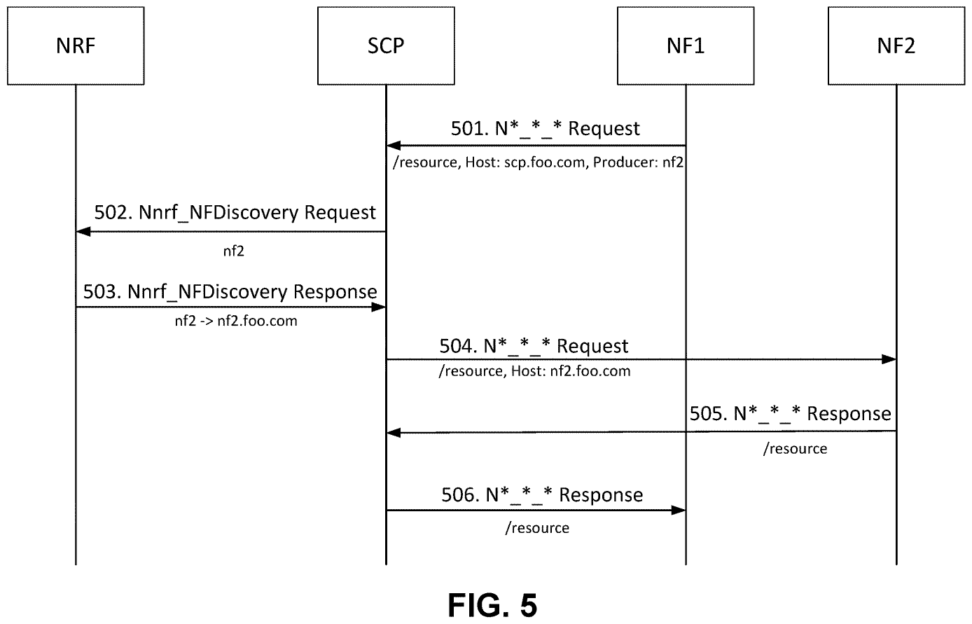

FIG. 5 is a message protocol chart illustrating an example indirect communication model, according to an embodiment. An indirect communication model, such as Model D, may be provided in embodiments. In Model D, consumers may implicitly know the addressing identifier of an SCP (e.g., an IP address or an FQDN) and may issue a request directly to the SCP. A consumer request may also include, e.g., discovery and/or selection parameters. The SCP may use such selection parameters to discover an appropriate producer instance via an NRF. The SCP may route the request and response packets.

FIG. 5 may illustrate an example indirect communication model in accordance with Model D, as described herein. In embodiments, a consumer may not perform a producer discovery, but the SCP may perform producer discovery. This model may be denoted as “delegated discovery.” At 501, a consumer (e.g., NF1) may issue a request for a producer (e.g., NF2) with the SCP as the host. An identifier for the SCP may be implicitly known to NF1. At 502, the SCP may request an identifier for an instance of NF2 via the NRF. At message 503, the NRF may respond to the SCP with the identifier (e.g., nf2.foo.com). At 504, the SCP may replace the Host value with one provided by the NRF and may route the request to NF2. At 505, NF2 may respond to the request from the SCP. At 506, the SCP routes the response message from NF2 to NF1.

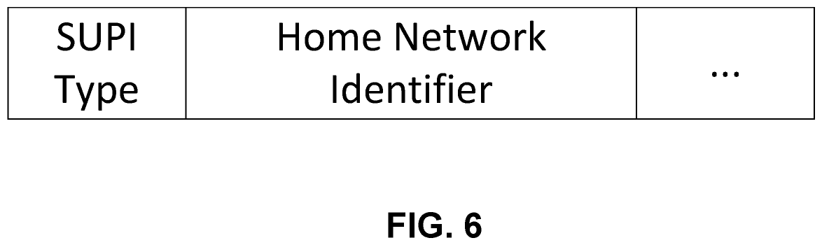

An example subscription concealed identifier (SUCI) is provided herein. FIG. 6 shows an example structure of an identifier, such as a SUCI. A SUCI may include at least two fields (e.g., a SUPI Type and a Home Network Identifier). A SUPI Type may define the type of SUPI concealed in the SUCI. For example, value 0 may correspond to an International Mobile Subscriber Identity (IMSI), value 1 may correspond to a Network Access Identifier (NAI), and values 2-7 may be preserved for other uses (e.g., a future use). A Home Network Identifier may be set by a Home Public Land Mobile Network (HPLMN) and may include a Mobile Country Code (MCC) and a Mobile Network Code (MNC) of the IMSI for value 0 SUPI Type. The Home Network Identifier may include a string of characters of variable length representing a domain name for value 1 SUPI Type.

Feature(s) associated with control and user plane separation through network slicing are provided herein. Network slicing concepts may support different QoS configurations (e.g., requirements) on the user plane. Network slicing concepts may enable the separation (e.g., entire separation) of Core Network instances specific for a network slice (e.g., identified via pre-defined slice/service types (SSTs)). Optional slice differentiators (SDs) may be used to differentiate network slices of the same type.

It may be beneficial to separate the UPFs (e.g., as well as the related Core Network functions that control the respective UPFs, for example, SMF, PCF, and/or AMF). For example, the UPFs may be separated if one UPF implements a first type of communication for a first packet data unit (PDU) session type (e.g., standard best effort user plane communication for PDU session type IP) and another UPF implements a second type of communication for a second PDU session type (e.g., time-sensitive networking for PDU session type ethernet).

Support for network slice selection assistance information (NSSAI) by gNBs and AMFs may be (pre-) configured (e.g., by an operator). The two endpoints may establish a connection via N2 if the provided NSID(s) match. When a WTRU requests a PDU session, the WTRU may provide the NSID (e.g., among other information) in the request to the AMF. The AMF may request (e.g., from the NSSF) an NRF service or service endpoint to use. The AMF may use the NSID and/or other information to determine which SMF service or service endpoint to use when asking the NRF for the FQDN or IP address of the SMF. The AMF may address the request for a new PDU session (or any other PDU session action, such as modification or release) to an SMF that is able to configure the UPF that provides support for the requested network slice (QoS).

Identifiers for producers may be of type IP address or FQDN. The NRF may hold one or more NF registrations. The NRF may be responsible for selecting which producer instance or set of instances (e.g., NF set) to which a consumer request may be sent. In an end-to-end service-based architecture, where SBIs may replace the NAS on the WTRU and/or AMF, the WTRU may not have the means to contact the NRF to obtain the identifier for the producer that the WTRU aims to reach. If the WTRU is a producer, Core Network consumers (e.g., other than the WTRU) may not have a means of addressing the WTRU.

The communication attempt of one or more consumers may involve one or more NRFs across one or more communication models (e.g., communication models A, B, C, and D, as described herein). This may delay establishing the service and create additional signaling, which may lead to higher energy consumption. In a multi-vendor Core Network deployment, a NF may be provided by a specific vendor. The logic within the NRF to select the appropriate producer instance (or NF set) may rely on the specific vendor.

When network slicing is used to request a user plane with QoS specifications, a design of the system architecture may use various NFs to request information regarding which FQDN or IP address to use for the next producer (e.g., which may involve using yet another producer). These requests may introduce additional signaling, which may result in higher latencies and power consumption (e.g., of the 5G Core Network).

Method(s) and/or device(s) are provided herein for unifying the naming convention of producer identifiers using FQDNs. WTRUs may also use the naming convention. Methods and/or devices described herein provide techniques for one or more WTRUs determine the FQDN without communicating with the NRF. Feature(s) associated with native support for network slicing as a part of a unified naming convention of producers are provided herein. Methods and/or devices described herein provide additional signaling that one or more consumer(s) may use to query the NRF for the identifier of the producer(s) the consumer(s) want to reach. An example service communication proxy model is provided herein. As described herein, Model C and Model D may permit the usage of an SCP for routing purposes. Model C may enforce indirect communication without delegated discovery, while Model D may enforce indirect communication with delegated discovery. Model C may enable consumers to discover an appropriate producer via the NRF, while Model D may enable consumers to issue requests directly to the SCP (e.g., with discovery and selection parameters included in the request). In indirect communications, the SCP may be addressed (e.g., addressed directly) using an IP address or FQDN, adding logic to the consumer about the addressing of the SCP.

An example communication Model E is provided herein. Model E may position the SCP as a transparent routing component which may not be addressed directly. The SCP may offer a programmable API that may be used to configure the constraints and affinities under which consumer and producer instances may be matched and kept together.

A naming convention for one or more producers is provided herein. In embodiments, producers may be identified through IP addresses or FQDNs. For example, producers may be identified with FQDNs when using an indirect communication model (e.g., Model C and/or Model D), allowing cloud-native procedures to take place. One or more consumers may utilize FQDNs for communication with producers. This may, for example, enable consumer implementations to avoid deployment specification realizations (e.g., such as the usage of IP addresses). The avoidance of IP addresses may allow a Core Network deployment to be scaled with any number of instances across a range of locations, independently from the implementation.

When a Core Network is deployed, one or more instances of the Core Network may offer control plane services collectively, forming a collective control plane service offering to WTRUs. This service offering is reflected in the FQDN through the definition of a parent domain (e.g., foo.com) to identify the service. In the case of a 5GC, for example, the domain may be the operator's name followed by the country into which it is deployed (e.g., foo.co.uk, foo.it or foo.es for Operator Foo in the United Kingdom (.co.uk), Italy (.it), or Spain (.es), respectively). Further differentiation of Core Network deployments of the same operator into the same country may be part of forming the parent domain (e.g., private network deployments or regional differences).

If a consumer requests to communicate with a NF, the consumer may know which NF to target, as one or more SBIs may be provided. For example, if an AUSF requests to authenticate a user as part of a registration procedure, the AUSF may know that it is capable of communicating with the UDM. The AUSF may construct an FQDN for the UDM so that the AUSF may address the UDM. The UDM (e.g., the defined name of the UDM, which may be implicitly known) may become a sub-domain under the parent domain (e.g., udm.foo.com where udm may be the sub-domain of the parent domain foo.com). The sub-domain may also be referred to as a PQDN. The same may apply to other NFs. For example, a PQDN (e.g., sub-domain) for an NRF may be nrf, a PQDN (e.g., sub-domain) for an AMF may be amf, etc.

In embodiments, WTRUs may use HTTP-based communication (e.g., attachment, PDU session establishment, or mobility communication) in sending requests toward the Core Network. In embodiments, WTRUs may use HTTP-based communication to reach any NF in the Core Network and vice versa. A WTRU may be associated with a sub-domain (e.g., a unique sub-domain) under the parent domain. In embodiments, WTRUs may behave as producers.

Feature(s) associated with the registration of producers are provided herein. In embodiments, a dedicated FQDN registration and/or deregistration API may be exposed by one or more SCPs. Such an API may include a routing layer capable of obtaining registration information about a specific producer, allowing a request from a consumer to be routed to the producer. Such registration information may include, for example, an identifier of an FQDN the producer serves (e.g., udm.foo.com), the producer's IP address, the transport layer port, and which transport layer protocol the producer uses. In embodiments, the registration information may be provided to the SCP by, for example, the producer or an orchestration framework during Core Network deployment.

An example method for obtaining a parent domain of a deployed core network is provided herein. An example description is provided for how consumers may obtain a parent domain to form an FQDN for request message construction to a producer deployed in a Core Network.

Feature(s) associated with core network functions are provided herein. For example, if a consumer instance bootstraps, the consumer may request information about the parent domain of the Core Network (e.g., to which the consumer belongs) in order to form the FQDN to communicate to other producers. In embodiments, to avoid a deployment-specific parent domain value, an SCP may offer a dedicated API capable of allowing consumers to retrieve information about the consumer's parent domain and/or other consumer-specific information. In embodiments, the FQDN under which the SCP may offer the API may be known to one or more consumers.

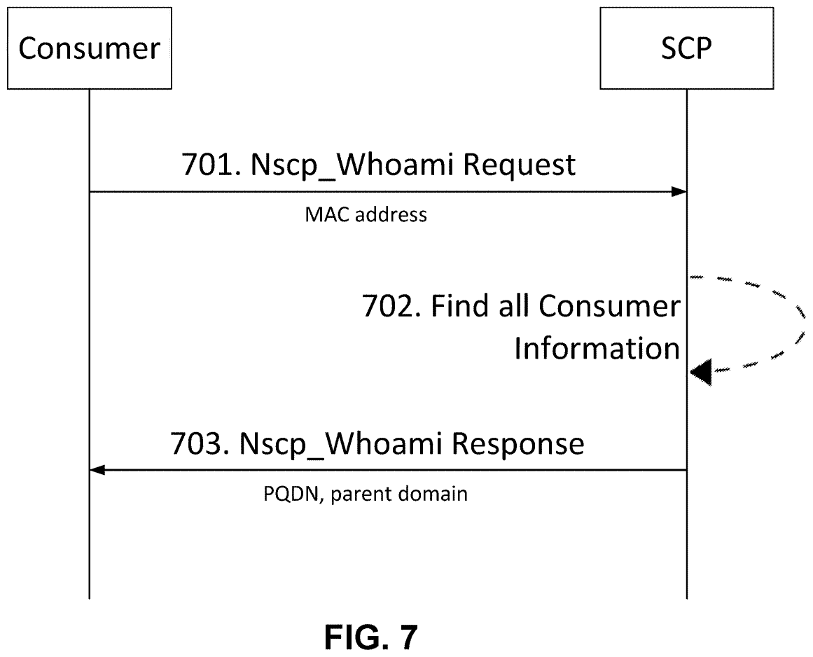

FIG. 7 is a message protocol chart illustrating an example procedure for a consumer to retrieve consumer information from an SCP. For example, FIG. 7 illustrates a procedure to utilize example Nscp_Whoami request/response primitives by a consumer. At 701, a consumer may issue an Nscp_Whoami request (e.g., using HTTP method POST) to whoami.scp with the consumer's own MAC address as the identifier. In embodiments, the procedure may be available to WTRUs and/or consumers. At 702, the SCP may use the MAC address provided to find one or more consumer-related details, such as those described herein (e.g., during deployment and registration). At 703, the SCP may respond to the consumer with an Nscp_Whoami response message including the PQDN of the consumer and/or of the parent domain.

In embodiments, a WTRU may not have been deployed in a similar fashion as the Core Network, and so the SCP may require another means of obtaining the parent domain to form FQDNs. The Horne Network Identifier of the SUCI may be used by the SCP to determine a parent domain value. In examples, if the consumer request SUPI type is IMSI, the Home Network Identifier is the confirmed PLMN ID, composed of MCC and MNC. Following the convention of FQDNs to have country or organization types as TDLs (e.g., .uk for United Kingdom), the MOC may be used as the TDL with the MNC as the sub-domain. The parent domain (e.g., associated with a network node) may be determined based on the SUPI type. For example, on a condition that the SUPI type is IMSI, the parent domain is determined based on a mobile country code (MCC) as a top-level domain, and a mobile network code (MNC) as a subdomain (e.g., if the SUPI type is IMSI, the MCC is 001, and the MNC 01, the resulting parent domain may be 01.001). In examples, if the SUPI type is an NAI, the Home Network Identifier may include a string of characters of variable length representing a domain name. This string of characters (e.g., value) may be directly used as the parent domain (e.g., on a condition that the SUPI type is a network access identifier (NAI), the parent domain is the NAI). For example, if the NAI is foo.com, the parent domain may also be foo.com.

Example naming conventions of producers with support for network slicing are provided.

The NSSAI may be added as a PQDN to the FQDN so that communication (e.g., direct communication) may be created between a consumer and a producer (e.g., without the need to ask another producer for an FQDN or IP Address that can be used to reach the producer). If a WTRU requests a PDU session, the WTRU may communicate the pre-configured NSSAI as part of the request towards the AMF, or the NSSAI may be provided (e.g., in a SUCI) as part of the authentication response by the UDM (e.g., the authentication response sent back to the WTRU), If the authentication is completed, the WTRU may know the NSSAI and may use the NSSAI as a partial subdomain of the FQDN for a producer. The NSSAI may include the SST or the SST value. The NSSAI may form a sub-domain (e.g., the least significant sub-domain) of the FQDN (e.g., <NSSAI>.<PRODUCER>.<PARENT_DOMAIN>).

A PQDN (e.g., <PRODUCER>) may be a defined name (e.g., an acronym, for example, the official acronym) of the NF the producer implements. The parent domain may be the PLMN ID or NAI, as described herein.

Example WTRU-initiated control plane communication is provided herein. For example, an SBI-enabled WTRU may request an access token from the NRF (e.g., with or without NSSAIs), In embodiments, Core Network consumers and WTRU consumers may derive a parent domain through different methods, but the usage of the parent domain in conjunction with the PQDN of the producer (e.g., <PRODUCER>) may be similar.

Feature(s) associated with non-NSSAI-based communication are provided.

Examples of how WTRUs form an FQDN (e.g., for the NRF to use to obtain an access token) are provided. FIG. 8 is a message protocol chart illustrating a communication model for WTRU-initiated control plane communication. As shown at 801, one or more producers may be registered. For example, Core Network producer instances may be registered against the SCP. At 801.a, as part of the WTRU's attempt to attach to a network, the WTRU may read the Home Network Identifier. In embodiments, the SUPI type may be an IMSI comprising an MCC and an MNC. The Home Network Identifier may be composed of the MCC and MNC and the resulting parent domain may follow the order mnc.mcc (e.g., 01.001 where 001 is the top-level domain and 01 the sub-domain). In embodiments, the SUPI type may be an NAI. In such embodiments, the Home Network Identifier is a string of characters representing a domain name (for example, foo.com). At 801.b, the SCP may add information about the new producer instance to information storage. In embodiments, the SCP may look up NRF instances if the SCP receives a request to determine an appropriate instance for the consumer.

An example WTRU communication with an NRF producer instance is illustrated at 802. The WTRU may obtain a parent domain (e.g., Home Network Identifier) at 802.a, and may form an FQDN by combining a PDQN (e.g., nrf) and the parent domain at 802.b. For example, if the SUPI type is IMSI, the FQDN may be nrf.01.001. If the SUPI type is NAI, the FQDN may be nrf.foo.com (for example, using nrf as the PQDN and foo.com as the parent domain). The WTRU may send a message to the network node (e.g., NRF) using the determined FQDN to address the network node (e.g., the WTRU may issue a Nnrf_AccessToken_Get request to the FQDN determined in 802.b). In response to the Nnrf_AccessToken_Get request, the SCP may route the Nnrf_AccessToken_Get request to an appropriate instance from a stored list of registered producers (e.g., established at 801). The NRF may respond to the Nrf_AccessToken_Get request with an Nnrf_AccessToken_Get response, including the access token, or a specific denial. The SCP may route the response to the WTRU.

At 801.a, the WTRU may attempt to attach to a network and may read the Home Network Identifier. If the SUPI type is an IMSI, the Home Network Identifier may be composed of MCC and MNC and the resulting parent domain may follow the order mnc.mco, e.g., 01.001 where 001 may be the top-level domain and 01 the sub-domain. If the SUPI type is an NAI, the Home Network Identifier is a string of characters representing a domain name (e.g., foo.com).

At 801.b, the SCP may add the information about the producer instance to an internal list. This may allow the SCP to look up available NRF instances (e.g., all available NRF instances) if a request (e.g., a new request) arrives, and determine the appropriate instance that may serve the consumer.

At 802.a, the WTRU may attempt to communicate with the NRF to retrieve an access token. The WTRU may form the FQDN for the NRF using the parent domain, which may have been previously obtained, and may add the PQDN nrf to the parent domain (e.g., nrf.01.001 if the SUPI type is an IMSI, or nrf.foo.com if the SUPI type is a Network Access Identifier).

At 802.b, the WTRU may form the FQDN for the NRF using nrf as the PQDN and foo.com as the parent domain, for example, if the SUPI type is a Network Access Identifier.

At 802.c, the WTRU may issue an Nnrf_AccessToken_Get request to the FQDN determined at 802.b. The SCP may route the Nnrf_AccessToken_Get request to the appropriate instance from the list of registered producers.

At 802.d, the NRF may respond to the request with an Nnrf_AccessToken_Get response, which may comprise the access token (or a specific denial). The Nnrf_AccessToken_Get response may be routed to the WTRU via the SCP.

Feature(s) associated with NSSAI-based communication are provided.

Example addressing conventions, including NSSAIs, may involve the establishment of PDU sessions. If a WTRU requests a PDU session, an AMF may use the NSSF to obtain the FQDN or IP address of the NRF configured to serve discovery requests (e.g., subsequent discovery requests) for SMF and PCFs.

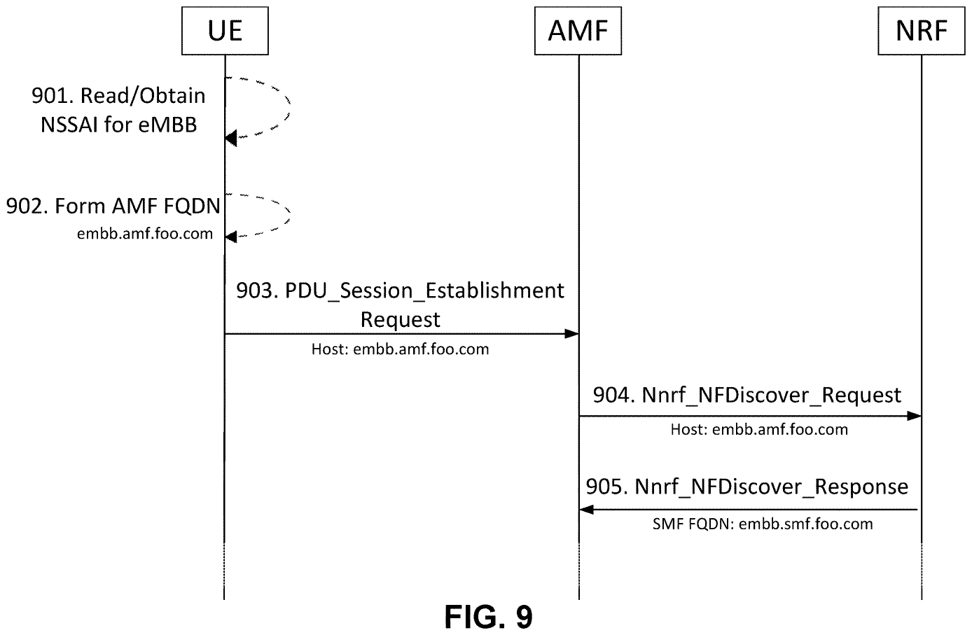

FIG. 9 is an example message sequence chart. FIG. 9 illustrates an example NSSAI-based addressing convention.

At 901, the WTRU may read/obtain the NSSAI for eMBB (e.g., either through pre-configuration or during authentication procedures, as described herein).

At 902, the WTRU may form the FQDN towards the AMF (e.g., as described herein). The WTRU may determine a slice type or a service type associated with a message being sent to the AMF. The WTRU may modify the PQDN based on the slice type or the service type. For example, the WTRU may add the slice type or the service type (e.g., embb) or an SST value (e.g., 1) as a sub-domain to the PQDN and parent domain amf.foo.com (e.g., thereby producing embb.amf.foo.com).

At 903, a PDU session establishment request may be sent to the AMF using the FQDN determined at 902 (e.g., the host may be embb.amf.foo.com).

At 904, the AMF handling the request may know (e.g., implicitly know) that the AMF is serving eMBB slices. The AMF may communicate with the appropriate NRF (e.g., which is reachable via embb.nrf.foo.com) to obtain the FQDN or IP address of the SMF.

At 905, the NRF may provide the AMF with the FQDN of the SMF (e.g., the SMF FQDN may be embb.smf.foo.com).

One or more options may be considered if an optional SD is used to differentiate slices of the same SST. In a first example option, the SD may be used as a subdomain by the WTRU under the parent domain <NSSAI>.<PRODUCER_ID>.<PLMN_ID>. If the SD is a 24-bit integer number (e.g., a pure integer number of length 24 bits), the resulting FQDN may start with an integer number in the range of 1 through 16,777,215 followed by the parent domain (e.g., <NSSAI>.<PRODUCER_ID>.<PLMN_ID>).

In a second example option, the SD may not be used to form the FQDN. The NSSAI (e.g., only the NSAAI) may be used to form the FQDN.

A UDM may convey addressing convention information (e.g., in a SUCI as part of the authentication where the NSSAI to choose is communicated to the WTRU) so that WTRUs know which addressing convention is implemented (e.g., in the Core Network to which the WTRUs want to attach). The WTRU may aim to resolve the FQDN formed with the SD as a subdomain. If the DNS server responds with an NXDOMAIN response (e.g., “FQDN cannot be resolved”), the WTRU may use the FQDN formed without the SD as a subdomain (e.g., formed using only the NSAAI).

1. A wireless transmit/receive unit (WTRU) for communicating with a network node, the WTRU comprising:
a processor, wherein the processor is configured to:
determine a subscription permanent identifier (SUPI) and a SUPI type;
determine, based on the SUPI type, a parent domain associated with the network node, wherein the network node is associated with a network function (NF);
determine a partially qualified domain name (PQDN) associated with the network node based on a defined name associated with the NF;
determine a fully qualified domain name (FQDN) for the network node based on the parent domain and the PQDN; and
send a message to the network node using the determined FQDN to address the network node.

2. The WTRU of claim 1, wherein the processor being configured to determine, based on the SUPI type, the parent domain associated with the network node comprises the processor being configured to:
on a condition that the SUPI type is an international mobile subscriber identity (IMSI), determine the parent domain associated with the network node based on a mobile country code (MCC) as a top-level domain, and a mobile network code (MNC) as a subdomain.

3. The WTRU of claim 1, wherein the processor being configured to determine, based on the SUPI type, the parent domain associated with the network node comprises the processor being configured to:
on a condition that the SUPI type is a network access identifier (NAI), determine that the parent domain associated with the network node is the NAI.

4. The WTRU of claim 1, wherein the processor being configured to determine the SUPI and the SUPI type comprises the processor being configured to read the SUPI and the SUPI type from a universal subscriber identity module (USIM) of the WTRU.

5. The WTRU of claim 1, wherein the processor being configured to determine the PQDN associated with the network node based on the defined name of the NF comprises the processor being configured to:
receive an indication of the defined name associated with the NF; and
assign the defined name associated with the NF as the PQDN.

6. The WTRU of claim 1, wherein the message to the network node is a first message, and wherein the processor is further configured to receive a second message from the network node based on the determined FQDN and a subscription concealed identifier (SUCI).

7. The WTRU of claim 1, wherein:
the message to the network node is a first message comprising an access token request;
the network node comprises a network repository function (NRF); and
the processor is further configured to receive, from the NRF, a second message comprising an access token response message.

8. The WTRU of claim 1, wherein the network node comprises an access and mobility management function (AMF), and wherein the message to the network node comprises a packet data unit (PDU) session establishment request.

9. The WTRU of claim 1, wherein the processor being configured to determine the FQDN for the network node based on the parent domain and the PQDN comprises the processor being configured to:
determine a slice type or service type associated with the message; and
modify the PQDN based on the slice type or the service type.

10. The WTRU of claim 1, wherein the network node comprises a network function, and wherein the network function is at least one of a network repository function (NRF), an access and mobility management function (AMF), a unified data management (UDM) function, a session management function (SMF), a policy control function (PCF), or a user plane function (UPF).

11. A method for a wireless transmit/receive unit (WTRU) to communicate with a network node, the method comprising:
determining a subscription permanent identifier (SUPI) and a SUPI type;
determining, based on the SUPI type, a parent domain associated with the network node, wherein the network node is associated with a network function (NF);
determining a partially qualified domain name (PQDN) associated with the network node based on a defined name associated with the NF;
determining a fully qualified domain name (FQDN) for the network node based on the parent domain and the PQDN; and
sending a message to the network node using the determined FQDN to address the network node.

12. The method of claim 11, wherein determining, based on the SUPI type, the parent domain associated with the network node comprises:
on a condition that the SUPI type is an international mobile subscriber identity (IMSI), determining the parent domain associated with the network node based on a mobile country code (MCC) as a top-level domain, and a mobile network code (MNC) as a subdomain.

13. The method of claim 11, wherein determining, based on the SUPI type, the parent domain associated with the network node comprises:
on a condition that the SUPI type is a network access identifier (NAI), determining that the parent domain associated with the network node is the NAI.

14. The method of claim 11, wherein determining the SUPI and the SUPI type comprises reading the SUPI and the SUPI type from a universal subscriber identity module (USIM) of the WTRU.

15. The method of claim 11, wherein determining the PQDN associated with the network node based on the defined name of the NF comprises:
receiving an indication of the defined name associated with the NF; and
assigning the defined name associated with the NF as the PQDN.

16. The method of claim 11, wherein the message to the network node is a first message, and wherein the method further comprises receiving a second message from the network node based on the determined FQDN and a subscription concealed identifier (SUCI).

17. The method of claim 11, wherein:
the message to the network node is a first message comprising an access token request;
the network node comprises a network repository function (NRF); and
the method further comprises receiving, from the NRF, a second message comprising an access token response message.

18. The method of claim 11, wherein the network node comprises an access and mobility management function (AMF), and wherein the message to the network node comprises a packet data unit (PDU) session establishment request.

19. The method of claim 11, wherein determining the FQDN for the network node based on the parent domain and the PQDN comprises:
determining a slice type or service type associated with the message; and
modifying the PQDN based on the slice type or the service type.

20. The method of claim 11, wherein the network node comprises a network function, and wherein the network function is at least one of a network repository function (NRF), an access and mobility management function (AMF), a unified data management (UDM) function, a session management function (SMF), a policy control function (PCF), or a user plane function (UPF).
